(19) United States
(12) Patent Application Publication
(10) Pub. No.: US 2009/0278271 A1
(43) Pub. Date: Nov. 12, 2009

(54) Thermal Revitalization of Polymer-Containing Materials

(76) Inventors: Jason L. Wolfe, Ennis, TX (US); Phillip Kleinlauth, Ovilla, TX (US)

Correspondence Address: BAKER BOTTS L.L.P., 30 ROCKEFELLER PLAZA, 44TH FLOOR, NEW YORK, NY, 10112-4498, US

(21) Appl. No.: 12/117,064

(22) Filed: May 8, 2008

(51) Int. Cl. B29C 73/00

(52) U.S. Cl. 264/36.22; 425/11

(57) ABSTRACT

A method for thermally revitalizing a damaged polymer-containing material, consisting essentially of applying heat from an external heat source to the surface of the object to temporarily raise the surface temperature of the object above the softening point of the polymer is disclosed. A device for performing thermal revitalization on a polymer-containing material is also disclosed.

### BACKGROUND OF INVENTION

Plastic composite (PC) deck boards are prone to being scratched or scuffed, either from normal wear and tear or from consumer usage such as moving picnic tables, grills, ornamentation, or other patio furniture across them. Additionally PC deck boards will experience color fade and chalking from normal exposure to the outside elements or from accelerated weathering tests which employ the use of a Weather-ometer® or QUV™ accelerated weathering laboratory testing devices.

Similarly, plastic patio furniture, such as lawn chairs, garden pots, and other plastic materials based on a variety of polymer resins can suffer from similar effects from environmental exposure and ordinary use.

### SUMMARY

The present invention relates to a method and apparatus for thermal revitalization of polymer-containing materials.

It is an object of the present invention to provide an effective low-cost method for the removal of damage such as scratches, scuffing, chalking and color fading that occurs from the exposure of objects composed of polymer-containing materials to the outside elements and from normal wear-and-tear. In one embodiment, a heat source is used to raise the surface temperature of the object to a temperature 20-60 degrees over the softening point of the polymer component of the object, at which point the thermal revitalization reaction can occur.

It is a further object of the present invention to provide an apparatus for reliably and efficiently performing thermal revitalization on plastic and plastic composite objects with large surface areas such as patio decks, and other situations where use of small, handheld device may lead to poor results.

### BRIEF DESCRIPTION OF THE DRAWINGS

FIG. 1 is a graph of the results of an embodiment of the thermal revitalization process, showing the color fading of thermally-revitalized GAF/Elk CrossTimbers® deck boards versus new GAF/Elk CrossTimbers® deck boards after accelerated weathering in a QUV® device.

FIG. 2 is a graph of the results of an embodiment of the thermal revitalization process, showing the color fading of thermally-revitalized GAF/Elk Weatherwood® with CrossTimbers® PC deck boards versus new GAF/Elk Weatherwood® with CrossTimbers® PC deck boards after accelerated weathering in a QUV® device.

FIG. 3 is a graph of the results of an embodiment of the thermal revitalization process, showing the Modulus of Rupture of both new and thermally revitalized deck boards.

FIG. 4 is a graph of the results of an embodiment of the thermal revitalization process, showing the Modulus of Elasticity of both new and thermally revitalized deck boards.

FIG. 5 is a representation of an embodiment of a device for performing the process of thermal revitalization on a polymer-containing material.

### DETAILED DESCRIPTION

The present invention relates to a method for restoring the surface finish of a plastic or PC object by the application of heat to the surface of the object from an external source. When the surface of the object reaches the proper temperature, the thermal revitalization reaction occurs, which removes damage such as scratches, scuffing, color fading, and chalking.

Plastic composite products generally include a filler and a polymer. Thermal revitalization may be carried out on PC products incorporating a variety of polymers such as polypropylene, polyethylene, or polyvinyl chloride (PVC). Similarly, PC products incorporating various fillers are compatible with the thermal revitalization process, such as: wood fibers from any type of wood, including hardwoods and softwoods, rice hulls, wheat hulls, wheat straw, flax, kenaf, corn stalks, corn ears, nuts, nut shells, peanuts, peanut shells, walnut, walnut shells, or glass beads.

The precise temperature necessary to cause the thermal revitalization process to occur will be different for each product, and depend on the particular combinations of polymers and other materials used in its construction. In order for the reaction to occur, the surface temperature of the object must be raised to a temperature above the softening point of the polymer, for example about 20 to 60 degrees Fahrenheit higher, through the use of an external heat source. This will allow the thermal revitalization reaction to occur and remove the imperfections. The softening point of the polymer may be determined using the Vicat test, ASTM D 1525, ISO 306. In general, applying the thermal revitalization process to PC products and plastics will improve the color and surface integrity of the product being treated.

Applying thermal energy from the external heat source too quickly or at too close a distance is counterproductive, as the surface temperature of the object may be raised to a level too far above the softening point of the polymer, leading to scorching, burning, or otherwise damaging the surface. As the effects of the reaction occur quickly and may be visually observed, the easiest way to prevent damage to the surface of the object is to visually inspect the object during treatment.

High air flow and a significantly higher heat temperature than that of the softening point of the polymer, such as 500-700 degrees Fahrenheit higher, aid in the process of thermal revitalization. For example, if the surface temperature at which the thermal revitalization reaction occurs is 320° F., applying heat of that temperature to the surface of the object will not be conducive to the process, and will instead necessitate a long application time and could negatively affect the structural integrity of the object. Instead, applying heat of a much higher temperature, such as 800-1000° F., will promote the reaction and allow it to quickly occur.

The external heat source may be a heat gun, a propane torch, or any other device capable of rapidly raising the surface temperature of an object. The greater temperature of the propane torch allows the process to be carried out faster than if a heat gun was used, but also increases the danger of accidentally damaging the surface of the object by applying too much thermal energy to the surface, thereby raising the surface temperature far above the softening point of the polymer.

If scorching or burning as a result of the application of too much thermal energy does occur, remedial action is possible. The damaged surface layer may be removed, for example, with sandpaper or other abrasives. This will allow a fresh area to be exposed, and the process may be attempted again by applying heat of a lower temperature or at a greater distance from the surface.

In general, thermal revitalization of polymer-containing materials will aid in restoring their finishes to a more desirable look after an extended weathering time. The process may also be used on new materials that are scratched, dulled, or oxidized from packaging, transport, or installation.

To test the process, a Milwaukee™ Model-2000D Variable Temperature Heat Gun was used to treat a weathered GAF/Elk CrossTimbers® deck board PC product. The deck board was faded in a QUV® accelerated weathering machine for 1400 hours, resulting in heavy chalking and fading to a delta-E of 20-23. Heat was applied to the weathered surface of the board utilizing the heat gun at the highest setting of 10 (800-1000° F.) at a distance of approximately two inches from the surface to the tip of the gun. A minimum surface temperature of 320° F. must be met in order for the thermal revitalization process to be effective on GAF/Elk CrossTimbers® products. The process was then repeated using a portable propane torch at a distance of approximately 5 inches from the tip of the flame to the surface of the board. In both cases, the weathered and faded deck boards were restored to within 1.0 delta E of their original color, with no visible chalking.

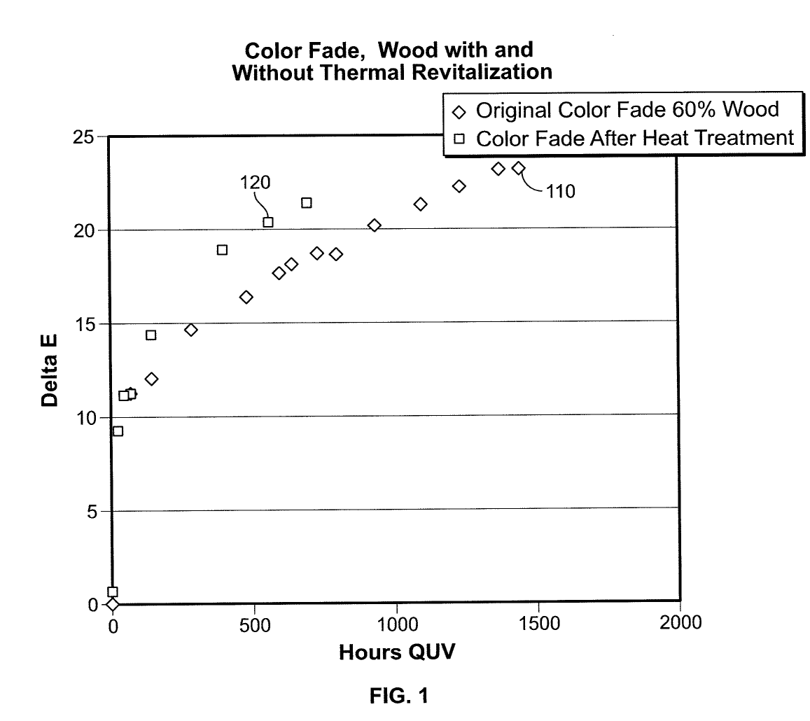

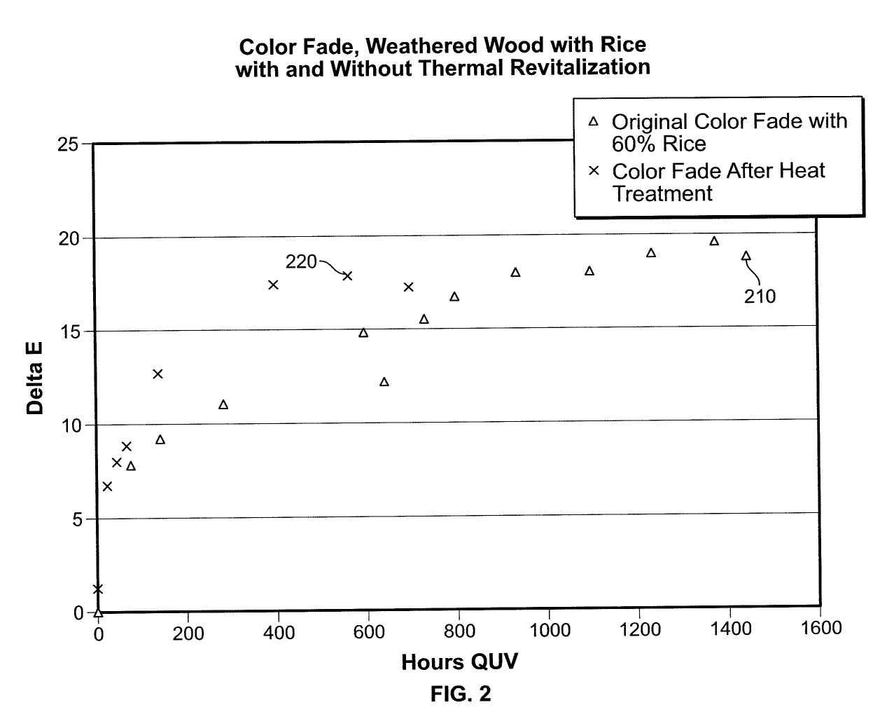

FIGS. 1 and 2 are graphs representing the color fading of samples of GAF/Elk CrossTimbers® and Weatherwood® with CrossTimbers® PC deck boards, respectively, treated according to an embodiment of the thermal revitalization process versus brand-new samples of the products after accelerated weathering in the QUV® device. As can be seen from the graphs, the revitalized deck boards (120 and 220) faded at only a slightly higher rate when compared to the untreated product (110 and 210).

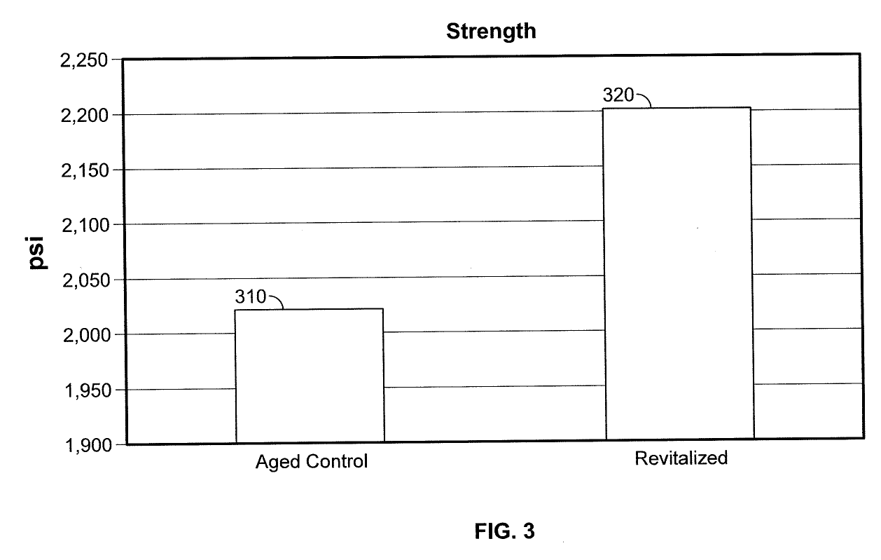

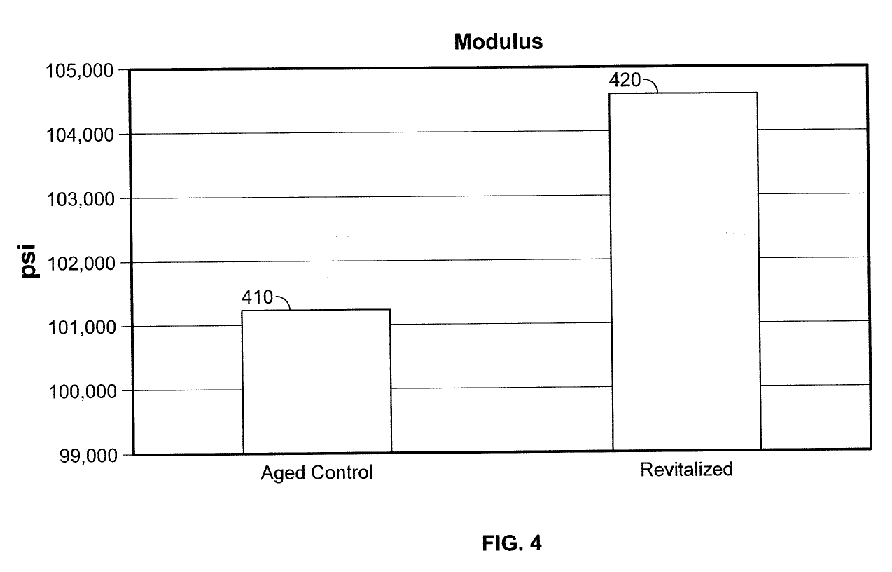

FIGS. 3 and 4 are graphs representing the Modulus of Rupture and Modulus of Elasticity, respectively, of both untreated and thermally revitalized deck boards. As can be seen from the graphs, the thermally revitalized boards (320 and 420) actually showed a slight increase in strength and flexural properties over the untreated boards (310 and 410).

In another embodiment of the invention, an apparatus for performing thermal revitalization of objects with large surface areas such as decks, floors, or roofs, is disclosed. Although all that is usually necessary to carry out the process of thermal revitalization is an external heat source such as a commercial heat gun or propane torch, the use of such devices may be impractical when attempting to thermally revitalize objects with large surface areas, such as a deck or a floor composed of PC boards. In these cases a specially designed thermal revitalization device may be used.

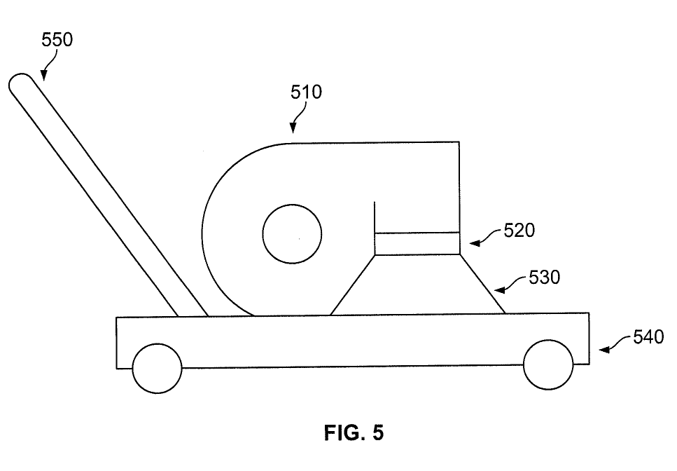

One such design is depicted in FIG. 5, and consists of an air flow generator 510, such as a fan or circulator; a heat source 520, such as an electric heating element or a gas burner; an exhaust duct 530, to direct the flowing air heated by the heat source over the surface to be treated; a carriage or chassis, 540, to support the weight of the device, allow easy maneuverability, and maintain the correct distance between the exhaust and the surface; and a handle 550. In one embodiment, the carriage is adjustable to allow the user to set the proper spacing after testing.

Those of ordinary skill in the art will appreciate that the foregoing discussion of certain embodiments are illustrative only, and does not limit the spirit and scope of the present invention, which is limited only by the claims set forth below.

1. A method for thermally revitalizing a damaged polymer-containing material comprising the steps of:
providing an external heat source;
positioning the external heat source at a distance from the surface of the polymer-containing material;
applying heat of a predetermined temperature range from the external heat source to the surface of the polymer-containing material; and
removing the external heat source after an interval of time so that the application and removal of heat results in a temporary elevation of the surface temperature of the polymer-containing material to about 20 to 60 degrees Fahrenheit above the softening point of the polymer, causing a thermal revitalization reaction to occur.

2. The method of claim 1 further comprising the step of using an abrasive material to prepare the surface prior to the step of applying heat.

3. The method of claim 1 wherein the interval of time is determined by visual observation of the thermal revitalization reaction.

4. The method of claim 1 wherein the distance is mechanically fixed

5. The method of claim 1 wherein the external heat source is a heat gun.

6. The method of claim 1 wherein the external heat source is a propane torch.

7. The method of claim 1 wherein the polymer-containing material is a plastic.

8. The method of claim 1 wherein the polymer is polypropylene.

9. The method of claim 1 wherein the polymer is polyethylene.

10. The method of claim 1 wherein the polymer is polyvinyl chloride.

11. The method of claim 1 wherein the polymer-containing material is a plastic composite comprising a filler and a polymer.

12. The method of claim 11 wherein the filler comprises wood fiber.

13. The method of claim 11 wherein the filler comprises rice hulls.

14. A device for performing thermal revitalization on damaged polymer-containing material comprising:
a carriage;
an air flow generator with an exhaust, mounted on the carriage, for producing flowing air;
a heat source with an inlet and an outlet, the inlet of the heat source attached to the exhaust of the air flow generator, for heating the flowing air;
an exhaust duct, attached to the outlet of the heat source, which passes through the carriage, and directs the heated flowing air towards the polymer-containing material; and
a handle, mounted to the carriage,
whereby the heated flowing air results in a temporary elevation of the surface temperature of the polymer-containing material to about 20 to 60 degrees Fahrenheit above the softening point of the polymer, causing a thermal revitalization reaction to occur.

15. The apparatus of claim 14 wherein the heat source is an electric heating element.

16. The apparatus of claim 14 wherein the heat source is a propane burner.

17. The apparatus of claim 14 wherein the air flow generator is a centrifugal fan.

18. The apparatus of claim 14 wherein the polymer-containing material is a plastic.

19. The apparatus of claim 14 wherein the polymer is polypropylene.

20. The apparatus of claim 14 wherein the polymer is polyethylene.

21. The apparatus of claim 14 wherein the polymer is polyvinyl chloride.

22. The apparatus of claim 14 wherein the polymer-containing material is a plastic composite comprising a filler and a polymer.

23. The apparatus of claim 22 wherein the filler comprises wood fiber.

24. The apparatus of claim 22 wherein the filler comprises rice hulls.
